(19) United States
(12) Patent Application Publication
(10) Pub. No.: US 2012/0090773 A1
(43) Pub. Date: Apr. 19, 2012

(54) PRODUCT PROTECTIVE FILM BONDING METHOD

(76) Inventor: SHIH-FONG LIN, Taipei Hsien (TW)

(21) Appl. No.: 12/905,107

(22) Filed: Oct. 15, 2010

(51) Int. Cl. B29C 65/78

(52) U.S. Cl. 156/196

(57) ABSTRACT

A product protective film bonding method includes the step of providing a film, the step of employing a screen printing technique to print an adhesive to one surface of the film corresponding to a part of the border of the configuration of the surface of the product to be protected, and the step of cutting the adhesive-printed film subject to the configuration of the surface of the product to be protected and then adhering the configured film to the surface of the product to be protected by means of the adhesive carried on the configured film.

### BACKGROUND OF THE INVENTION

a) Field of the Invention

The present invention relates to the technology of bonding a protective film to a product and more particularly, to a product protective film bonding method, which saves much adhesive consumption.

b) Description of the Prior Art

For protecting the surface of a computer, computer peripheral product, communication electronic product, LCD TV, etc. will be adhered with a layer of protective film before delivery from the factory. This protective film is a thin film of polyethylene, polyethylene terephthalate or poly propylene, and adhered to the surface of an electronic product by labor with a tool. Before bonding a protective film to the surface of an electronic product, an adhesive must be applied to the whole surface area of one side of the protective film, and then the back-glued protective film is properly cut subject to the size of the surface to be protected, and then the well-cut protective film is adhered to the surface of the electronic product for protection.

Due to the factors of weather, humility and labor skill, air bubbles may exit in between the protective film and the surface of the electronic product after bonding of the protective film, obstructing the sense of beauty of the product. Further, the adhesive may be not evenly covered on the whole surface of the protective film due to poor labor skill. After the consumer removed the protective film from thee surface of the electronic product, residual adhesive may be left on the surface of the electronic product. When a consumer encounters this problem, the consumer shall have to clean the surface of the electronic product with a solvent. When cleaning the surface of the electronic product with an improper solvent, the surface coating of the electronic product may be damaged. Further, when adhering a protective film to the surface of an electronic product under a high humility environment, moisture may permeate in between the protective film and the surface of the electronic product, causing the presence of a layer of foggy substance. Re-adhering the protective film will waste much labor and time, and will also increase the cost.

Further, it is expensive to apply an adhesive to the whole surface area of one side of a protective film. As the protective film bonding business is a business of low profit margin, a high adhesive consumption will greatly cut off the profit.

Further, an adhesive may be applied to the surface of a protective film by transfer printing. According to this method, an adhesive is coated on a strippable paper in advance. When gluing a protective film, bake the strippable paper to soften the adhesive, and then attach the strippable paper to the protective film, and then apply a pressure to the strippable paper against the protective film to have the adhesive be transfer-printed onto the protective film. This transfer printing technique improves the working efficiency, however it requires an extra strippable paper, increasing the cost.

Therefore, it is desirable to provide a product protective film bonding method, which eliminates the drawbacks of the aforesaid various conventional methods.

### SUMMARY OF THE INVENTION

The present invention has been accomplished under the circumstances in view. It is one object of the present invention to provide a product protective film bonding method, which is free from the interference of the factors of weather, humility and labor skill, assuring a high adhering quality and avoiding the problem of residual adhesive on the surface of the protect after removal of the protective film.

It is another object of the present invention to provide a product protective film bonding method, which saves adhesive consumption, thereby reducing the protective film bonding cost.

It is still another object of the present invention to provide a product protective film bonding method, which avoids the use of any strippable paper, thereby saving the cost.

To achieve these and other objects of the present invention, a product protective film bonding method the step of providing a film, the step of employing a screen printing technique to print an adhesive to one surface of the film corresponding to a part of the border of the configuration of the surface of the product to be protected, and the step of cutting the adhesive-printed film subject to the configuration of the surface of the product to be protected and then adhering the configured film to the surface of the product to be protected by means of the adhesive carried on the configured film.

Further, the step of employing a screen printing technique to print an adhesive to one surface of the film corresponding to a part of the border of the configuration of the surface of the product to be protected can be screen-printing the adhesive onto the film corresponding to two distal ends of the border of the configuration of the surface of the product, or corresponding to corners of the border of the configuration of the surface of the product, or corresponding to two distal ends of the border of the configuration of the surface of the product and a middle part of the border of the configuration of the surface of the product between said two distal ends, or corresponding to every angle of the border of the configuration of the surface of the product.

Further, the step of cutting the adhesive-printed film subject to the configuration of the surface of the product to be protected is to cut the adhesive-printed film into multiple individual protective films subject to the configuration of the surface of the product to be protected.

### BRIEF DESCRIPTION OF THE DRAWINGS

FIG. 1 is a flow chart of a product protective film bonding method in accordance with the present invention.

FIGS. 2A, 2B and 2C illustrate an application example of the present invention.

FIGS. 3A, 3B and 3C illustrate another application example of the present invention.

FIGS. 4A, 4B and 4C illustrate still another application example of the present invention.

### DETAILED DESCRIPTION OF THE PREFERRED EMBODIMENT

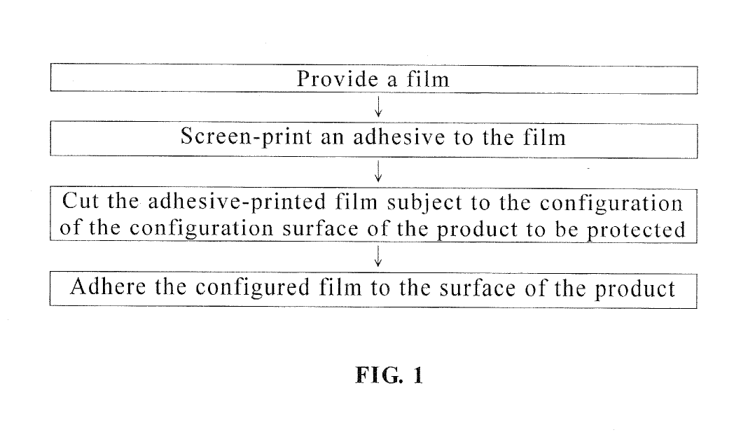

Referring to FIG. 1, a product protective film bonding method in accordance with the present invention includes the steps of (1) providing a film, (2) printing an adhesive to the surface of the film by screen printing, and (3) cutting the film and then adhering the film to the surface of the product to be protected.

The aforesaid second step of printing an adhesive to the surface of the film by screen printing is to employ a screen printing technique for printing an adhesive onto one surface of the prepared film corresponding to a part of the border of the configuration of the surface of the product to be protected. The aforesaid third step of cutting the film and then adhering the film to the surface of the product to be protected is to cut the adhesive-printed film into multiple individual protective films subject to the configuration of the surface of the product to be protected and then to adhere each individual protective film to the surface of one respective individual piece of the product to be protected by means of the adhesive at each individual protective film.

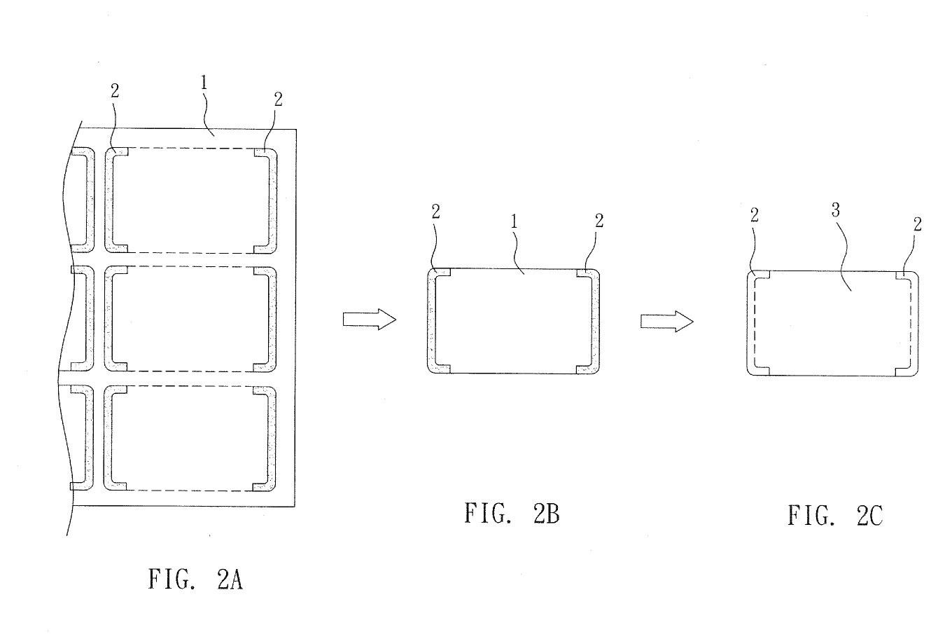

FIGS. 2A, 2B and 2C illustrate an application example of the present invention. According to this application example, the surface of the product 3 to be protected has a rectangular contour (see FIG. 2C). During application, employ a screen printing technique to print an adhesive 2 onto selected locations of the prepared film 1 subject to the rectangular contour of the product 3, for example, covering two opposite ends and four corners corresponding to the rectangular contour of the surface of the product to be protected (see FIG. 2A), and then cut the film into multiple protective films subject to the shape of rectangular contour of the surface of the product 3 to be protected (see FIG. 2B), and then adhere one individual protective film to the surface of one respective piece of the product 3 to protect the surface of the respective piece of the product 3 against scratching damage (see FIG. 2C).

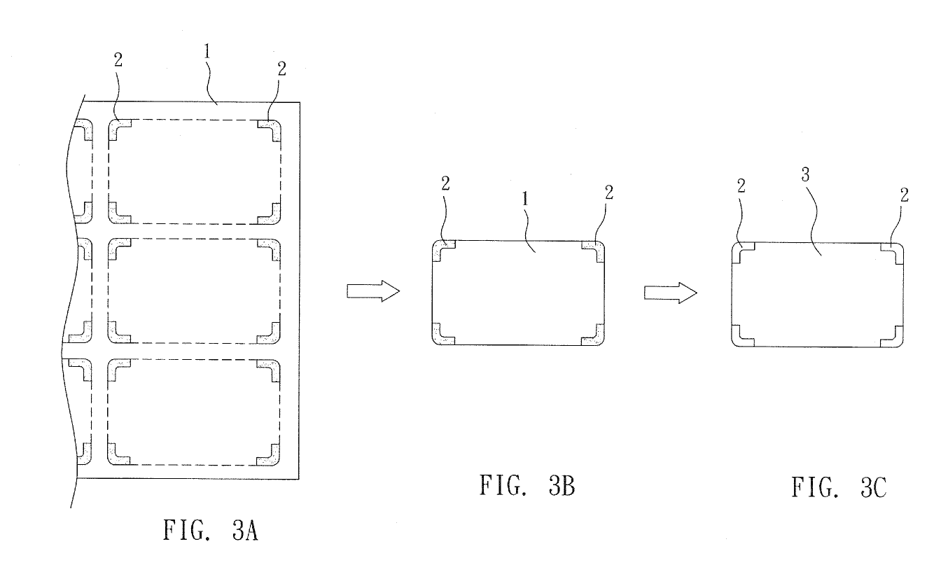

FIGS. 3A, 3B and 3C illustrate another application example of the present invention. According to this application example, the surface of the product 3 to be protected has a rectangular contour (see FIG. 3C). During application, employ a screen printing technique to print an adhesive 2 onto selected locations of the prepared film 1 subject to the rectangular contour of the product 3, for example, covering four corners corresponding the rectangular contour of the surface of the product to be protected (see FIG. 3A), and then cut the film into multiple protective films subject to the shape of rectangular contour of the surface of the product to be protected (see FIG. 3B), and then adhere one individual protective film to the surface of one respective piece of the product 3 to protect the surface of the respective piece of the product 3 against scratching damage (see FIG. 3C).

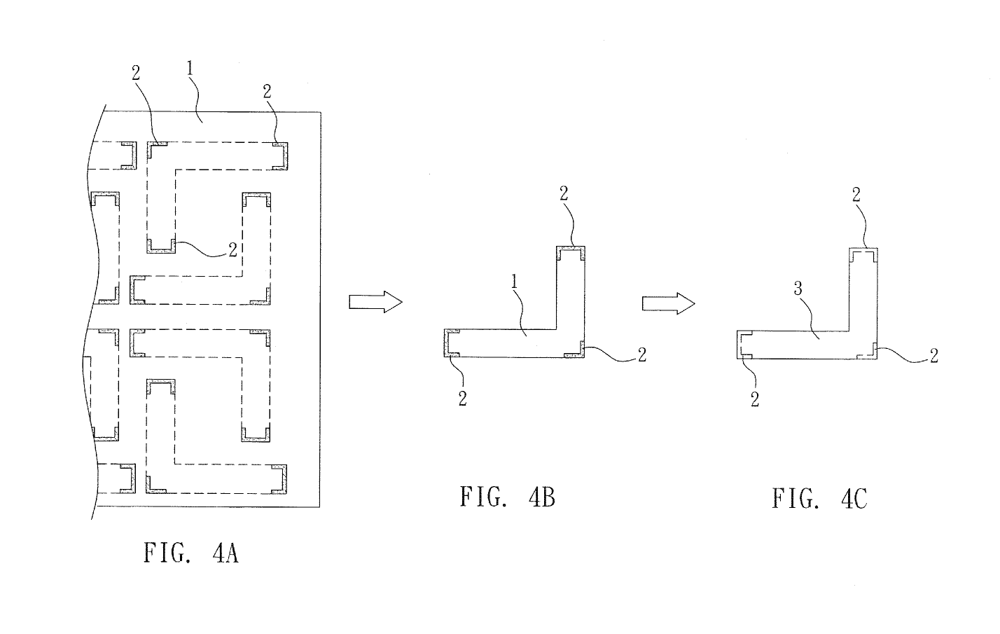

FIGS. 4A, 4B and 4C illustrate still another application example of the present invention. According to this application example, the surface of the product 3 to be protected has an L-shaped contour (see FIG. 4C). During application, employ a screen printing technique to print an adhesive 2 onto selected locations of the prepared film 1 subject to the L-shaped contour of the product 3, for example, covering the two opposite ends and angle of the L-shaped contour of the surface of the product to be protected (see FIG. 4A), and then cut the film into multiple protective films subject to the shape of rectangular contour of the surface of the product to be protected (see FIG. 4B), and then adhere one individual protective film to the surface of one respective piece of the product 3 to protect the surface of the respective piece of the product 3 against scratching damage (see FIG. 4C).

Subject to the aforesaid method, it simply needs to print an adhesive to a part of the prepared film corresponding to a part of the border area of the surface of the product to be protected, saving much the consumption of the adhesive. By means of employing a screen printing technique to print the adhesive to selected area of the prepared film instead of covering the whole surface area of the prepared film, the invention saves much the consumption of the adhesive without affecting the effect of protection of the protective film.

Although particular embodiments of the invention have been described in detail for purposes of illustration, various modifications and enhancements may be made without departing from the spirit and scope of the invention. Accordingly, the invention is not to be limited except as by the appended claims.

I claim:

1. A product protective film bonding method, comprising the steps of:
(a) providing a film;
(b) employing a screen printing technique to print an adhesive to one surface of said film corresponding to a part of the border of the configuration of the surface of the product to be protected;
(c) cutting the adhesive-printed film subject to the configuration of the surface of the product to be protected and then adhering the configured film to the surface of the product to be protected by means of the adhesive carried on the configured film.

2. The product protective film bonding method as claimed in claim 1, wherein the step (b) of employing a screen printing technique to print an adhesive to one surface of said film corresponding to a part of the border of the configuration of the surface of the product to be protected is to print said adhesive onto said film corresponding to two distal ends of the border of the configuration of the surface of the product.

3. The product protective film bonding method as claimed in claim 1, wherein the step (b) of employing a screen printing technique to print an adhesive to one surface of said film corresponding to a part of the border of the configuration of the surface of the product to be protected is to print said adhesive onto said film corresponding to corners of the border of the configuration of the surface of the product.

4. The product protective film bonding method as claimed in claim 1, wherein the step (b) of employing a screen printing technique to print an adhesive to one surface of said film corresponding to a part of the border of the configuration of the surface of the product to be protected is to print said adhesive onto said film corresponding to two distal ends of the border of the configuration of the surface of the product and a middle part of the border of the configuration of the surface of the product between said two distal ends.

5. The product protective film bonding method as claimed in claim 1, wherein the step (b) of employing a screen printing technique to print an adhesive to one surface of said film corresponding to a part of the border of the configuration of the surface of the product to be protected is to print said adhesive onto said film corresponding to every angle of the border of the configuration of the surface of the product.

6. The product protective film bonding method as claimed in claim 1, wherein the step (c) of cutting the adhesive-printed film subject to the configuration of the surface of the product to be protected is to cut said adhesive-printed film into multiple individual protective films subject to the configuration of the surface of the product to be protected.
